(19) United States
(12) Patent Application Publication
(10) Pub. No.: US 2007/0273549 A1
(43) Pub. Date: Nov. 29, 2007

(54) Integrated AMR-enabled solid-state utility meter with highly optimized processing ASIC

(76) Inventors: Timothy Ronald Jackson, Yorba Linda, CA (US); Michael Burdiek, Laguna Beach, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/710,707

(22) Filed: Feb. 24, 2007

Related U.S. Application Data
(60) Provisional application No. 60/786,789, filed on Mar. 29, 2006.

(51) Int. Cl. G08C 19/16

(52) U.S. Cl. 340/870.02

(57) ABSTRACT

The present invention discloses a method and apparatus for implementing an AMR-enabled solid-state utility meter based on a highly optimized processing allocation-specific integrated circuit (ASIC.) When the present invention is applied, the resulting solid-sate utility meter achieves improved cost, size, and complexity compared to prior art meters.

### CROSS REFERENCE TO RELATED APPLICATION

This application claims the benefit of Provisional Application 60/786,789 filed Feb. 28, 2006 the entire contents of which is hereby expressly incorporated by reference herein.

### DESCRIPTION

1. Field of the Invention

This invention relates to improvements in a solid-state utility meter. More particularly, to an AMR-enabled solid-state electricity meter that utilizes a highly optimized ASIC that integrates high precision sensor measurement capability, signal processing capability, memory, and communication capability in order to significantly reduce the size, cost, and complexity of said meter.

2. Background of the Invention

Several prior art solid-state electricity meters (SEM) and AMR-enabled SEM products are currently available in the market. Examples of such prior are SEM include Centron®, Sentinel®, and Quantum® product families from Itron, the I and kV series from GE, and the A-series and REX products from Elster. These prior art SEM are typically designed with the measurement feature only and have provisions for AMR capability to be added (via separate module) as an option in final assembly. The reason for this architecture is that many meters installed today do not require the AMR function. It has been more efficient for meter manufacturers to develop the meter and purchase AMR modules from 2^{nd} party vendors. In some cases (such as Itron) the meter company is vertically integrated and also develops the AMR module. To date there are no examples of SEM in which the AMR circuits are directly integrated onto the same PCB as the measurement electronics.

The AMR module generally mounts to the main board in the SEM and communicates with the meter using a serial port or UART. The AMR module also provides a communication channel back to a remote client. This communication channel can be wired or wireless. Wired versions include POTS modem, power-line modem, and in rare cases Ethernet. Wireless versions of AMR are more common, particularly short-range implementations that communicate on the 900 MHz ISM band using custom protocols. There are recent entrants to the market that are proposing the use of standards-based wireless communications such as 802.11 (WiFi) and 802.15 (ZigBee.)

Prior art SEM are typically architected using voltage and/or current sensors, a display unit, power conditioning circuitry, and a commercially available metering ASIC. Such ASICs integrate measurement channel(s), memory, processor, general purpose I/O, and communication port(s). Recent examples of such ASICs include the ADE775x and ADE776x families of products from Analog Devices, and the 71 M651x family of products from Teridian Semiconductor. These ASICs provide a serial port/UART for communicating to a separate AMR module, but to date none of these ASICs integrate any portion of the AMR function.

Prior art SEM implement the AMR function by connecting a separate AMR module to the communications port on the SEM. Prior art implementations include both “under the glass” architectures in which the AMR module is installed within the casing of the SEM; and external architectures in which the AMR module is attached outside of the casing of the SEM. In both of these cases, the manufacturing cost is increased due to the need of a electrical connector on the SEM, mechanical mounting provisions on the SEM, installation/assembly cost, and the associated costs of building the AMR module as a separate device.

### BRIEF SUMMARY OF THE INVENTION

It is an object of the improved solid state AMR to minimize limitations in the prior art devices by using a highly optimized ASIC. For this embodiment we illustrate a single-phase electricity meter implementation; however this does not in any way limit application of the present invention or prevent use of present invention in multi-phase electricity applications. In fact it is anticipated that the present invention will have embodiments that are optimized for multi-phase applications. It is also anticipated that present invention technology can be applied to other utility metering applications including gas and water metering.

It is another object of the improved solid state AMR to include sensors, a display unit, the highly optimized ASIC, RF Path, and power conditioning circuitry. Objectives of the present invention include but are not limited to:

Reducing the complexity of developing and producing an AMR-enabled solid-state meter;

Reducing the bill-of-materials required to produce AMR-enabled solid-state meter;

Reducing the cost for producing an AMR-enabled solid-state meter;

Reducing the area required for the main PCB in an AMR-enabled solid-state meter;

Reducing the overall size and volume of an AMR-enabled solid-state meter.

It is another object of the improved AMR to integrate both a measurement path and a communication path to achieve an optimized combination of cost, size, and design simplicity; and it does so by implementing a highly optimized ASIC that integrates key elements of the measurement path and communication path into a single device.

It is another object of the improved solid state AMR to directly integrate both the measurement path and the communication path (i.e. AMR module) onto the main printed circuit board (PCB) of the SEM. This eliminates the added cost of extra connectors, PCB, mechanical devices, and support circuitry found in prior art embodiments. This highly integrated approach also allows the use of the highly optimized ASIC.

It is another object of the improved solid state AMR to take advantage of the close integration of the measurement path and communication path on the main PCB, elements of measurement path (already available in prior art metering ASICs) to combine these elements with the communication path. The improved solid state AMR uses highly optimized ASIC to integrate the measurement channel(s), memory, processor, general purpose I/O, and communication port(s) (found on prior art ASICs) with the logic required to implement the physical (PHY) layer of the communications path and the firmware required to implement the media access (MAC) layer of the communication path.

It is another object of the improved solid state AMR to utilize spare bandwidth in the existing processor to run the MAC firmware and manage the PHY logic, thereby eliminating the need for the separate processor found in stand-alone communication ASICs. To further improve cost, the present invention modifies the analog-to-digital converters (ADC) (found in the measurement channels) such that they can sample and digitize the RF signal in the communication path. This results in a simplified RF implementation for the communication path and further cost reductions to the system.

It is still another object of the improved solid state AMR to eliminate much of the redundant support circuitry found in a communication ASIC such as power supply management, I/O circuits, timing management, memory bussing, etc. The highly optimized ASIC of the present invention results in a much smaller and more cost effective solution compared to an architecture using a separate metering ASIC in the SEM and communication ASIC in the AMR module.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows a preferred Top-level Block Diagram of a system using the improved solid state AMR.

FIG. 2 shows another preferred Top-level Block Diagram of the improved ASIC solid state AMR.

FIG. 3 shows a preferred embodiment of a Block Diagram of the RF Path.

### DETAILED DESCRIPTION

The following description is a preferred embodiment of the AMR-enabled solid-state electricity meter that utilizes a highly optimized ASIC referencing the included drawings which form a part hereof. The drawings show by way of illustration a specific embodiment in which the invention may be implemented. It is not intended in any way that said illustrations limit the scope of the invention to only the embodiment described herein. The present invention is also expected to be embodied in other forms not specifically addressed in the illustrations that form a part of this description.

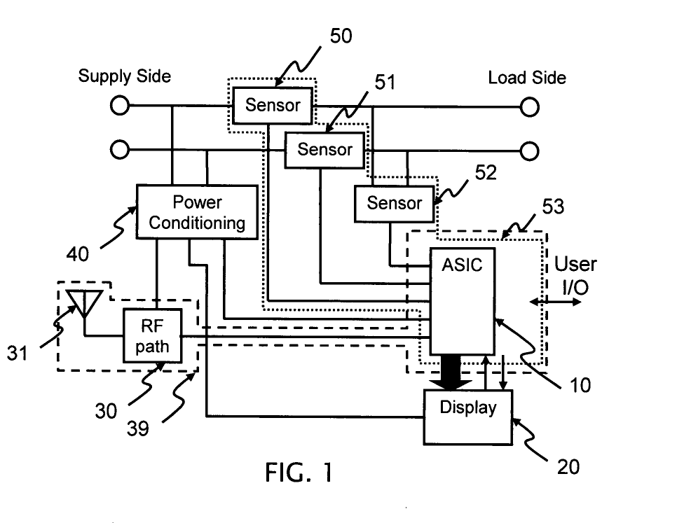

FIG. 1 shows the AMR-enabled solid-state electricity meter that utilizes a highly optimized ASIC, as a top-level block diagram. The system embodiment created by the present invention is comprised of several components namely the sensors 50-52, a display unit 20, the highly optimized ASIC 10, RF support circuitry 30, and power conditioning circuitry 40.

Highly Optimized ASIC 10

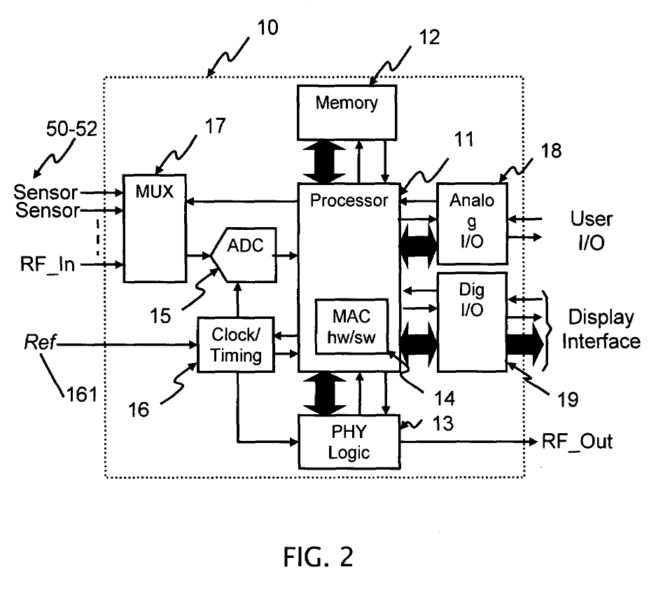

FIG. 2 shows a block diagram of the highly optimized ASIC 10, herein after referred to as “ASIC”. In this embodiment, the ASIC has several main blocks which include processor 11, memory 12, PHY logic 13, MAC hw/sw 14, clock/timing 16, ADC 15, multiplexer 17, analog I/O 18 and digital I/O 19.

The processor 11 is preferably a 32-bit, firmware driven processing core with memory bus and peripheral control capability but other types of processors are contemplated that would provide equivalent performance. The processor 11 operates by running program firmware stored in memory 12 and provides a majority of the processing functions on the ASIC. The memory 12 includes ROM, RAM, and optionally flash memory elements. The memory 12 is used to store program firmware, application data, and processing data. The PHY logic 13 is a block of custom logic that implements the physical (PHY) interface of the communication channel. The PHY logic 13 is designed such that an optimal balance is achieved between the PHY tasks performed by the PHY logic 13 and the PHY tasks performed by the processor 11. The MAC hw/sw 14 block implements the media access control (MAC) function of the communication channel. The MAC function is implemented as a combination of software/firmware stored in memory 12 and dedicated hardware logic.

The ADC 15 block serves as the measurement device for the measurement channel and a digitizing device for the communication channel. The ADC 15 measures the signal provided by the multiplexer MUX 17 and provides digitized data to the processor 11. The MUX 17 receives multiple analog input signals from the sensors 50-52 (FIG. 1), the RF path 30, and other potential analog sources; and passes one of these signals to the ADC 15 for measurement.

The clock/timing 16 block receives a reference clock signal Ref 161 and generates the appropriate timing and clock signals for other blocks in the ASIC. In a different embodiment of the ASIC, the ASIC generates the Ref signal on the ASIC. The analog I/O 18 includes analog functions such as temperature sensing, power supply voltage sensing, receive signal strength (RSS) sensing, etc. The digital I/O 19 block includes digital input and output functions such as but not limited to alpha/numeric display control, switch sensing, LED control, serial communication, etc.

Display Unit 20

The display unit 20 (FIG. 1) is typically an LCD alpha/numeric display that provides a visual read-out of measurement data. The display unit 20 may vary depending upon the features and functions of a given SEM.

RF Path 30

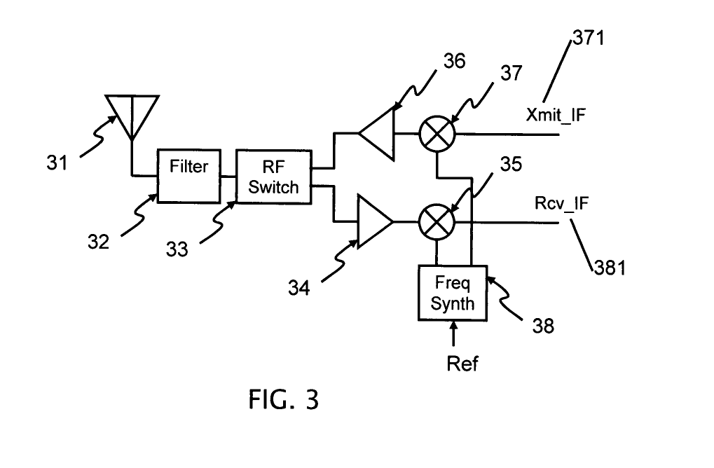

FIG. 3 illustrates the top-level block diagram of one embodiment of the RF Path 30 in a communication channel. The antenna 31 is used to collect signal energy during receive activity and radiate signal during transmit activity. The antenna 31 is connected to a filter 32 that provides a pass-band appropriate for the frequency band on which the channel communicates. The filter 32 is connected to the RF switch 33 that is used to select between the receive path and the transmit path of the system. One pole of the RF switch 33 connects to the low noise amplifier (LNA) 34 of the receive path. The low noise amplifier 34 amplifies the received signal and passes that signal to the downconvert mixer 35. The downconvert mixer 35 mixes the receive signal with a signal generated by the frequency synthesizer 38 in order to produce the receive intermediate frequency signal Rcv_IF 381.

The upconvert mixer 37 in the transmit path receives the intermediate frequency Xmit_IF 371 signal and mixes that signal with a signal generated by the frequency synthesizer 38 in order to produce the transmit RF signal. The output of the upconvert mixer 37 drives the input of the power amplifier 36. The output of the power amplifier 36 connects to one of the inputs to the RF switch 33.

System Operation

The AMR-enabled solid-state electricity meter that utilizes a highly optimized ASIC 10, as shown in FIG. 1.

Measurement Path 39

The ASEM uses a voltage sensor 52 and current sensors 50 to convert the high voltage and high current signals from the Supply Side into signals that can be effectively measured by the ASIC 10. An example of a voltage sensor 52 is a simple resistive divider circuit, although other voltage sensors may be implemented. An example of a current sensor 50 is a current transformer, although other current sensors may be implemented. The output of the voltage sensor 52 and current sensors 50, 51 are connected to the inputs of the MUX 17 in the ASIC 10 (FIG. 2). This implementation is similar to prior art embodiments of a SEM.

The processor 11 programs the input MUX 17 to select the appropriate sensors 50-52 input that is scheduled to be measured at a given time. The output of the MUX 17 is passed to the input of the ADC 15 where the signal is digitized for processing by the processor 11. By multiplexing the sensor inputs the ASIC 10 can use a single ADC 15 to measure multiple signals thereby reducing the ASIC 10 cost. Operating a single ADC 15 also significantly improves dynamic range and signal-to-noise ratio (SNR) by eliminating cross-talk typically experienced by operating multiple ADC channels on the same device.

The specific processing and calculation functions performed by the processor 11 are determined by the program firmware stored in the ASIC memory 12. The results of the processing and calculations performed by the processor 11 are stored in memory 12 for subsequent access by the communication path.

Communications Path 39 (FIG. 1)

The ASEM integrates a complete communication path, including the RF Path 39 (FIG. 1), PHY logic 13, and MAC 14 (FIG. 2) hardware and software. When the SEM is receiving communication data, the antenna 31 (FIG. 3) collects signal energy and passes that energy through the band-pass filter 32 which limits the signal content to only the frequencies that contain the data of interest to the system. The RF switch 33 is set to the receive path position such that the filtered signal is passed to the LNA 34. After amplification through the LNA 34 the signal is applied to the downconvert mixer 35 that mixes the signal with a local frequency signal generated by the frequency synthesizer 38. The output of the mixer 35 is an IF signal that is passed to the RF input of the multiplexer 17 (FIG. 2) of the ASIC 10. By configuring the RF in this manner and using the ADC 15 on the ASIC 10 to sample the IF, the RF path does not require additional filtering and amplification in order to reject images. This results in a less expensive and less complex RF design.

It is contemplated that the communications channel can be used to load new programs that can be stored in the memory in order to improve, update, replace, and/or augment the measurement function(s) associated with the measurement channel(s).

In receive mode, the multiplexer 17 is conFIG.d to pass the RF input signal to the ADC 15 for sampling and digitizing. The sample rate and resolution of the ADC 15 is determined by the IF, modulation scheme, and data rate of the communication channel implemented by the system. The present invention allows the sample rate and resolution of the ADC 15 to be programmed in various combinations resulting in a communication channel that can be adapted to multiple frequencies, modulation schemes, data rates, and protocols.

Note that the downconvert mixer 35 (FIG. 3) is an optional element in the RF path 30 depending upon the frequency band selected for the communication channel and the semiconductor process selected for implementing the ASIC 10. Implementations that communicate on lower frequency ISM bands (<400 MHz) and implement the ASIC 10 using 90 nm CMOS may choose to directly sample the output of the LNA 34 using the ADC 15 (FIG. 2) in the ASIC 10. Implementations that communicated on higher frequency ISM bands and/or implement the ASIC in 0.13 u CMOS (or larger) may downconvert the RF to a lower frequency IF using the downconvert mixer 35. The present invention applies to both of these implementations.

Once digitized, the resulting data is processed by the processor 11 using the PHY logic 13 and the MAC hardware/software 14. The resulting data is used by the processor 11 to determine what functions to perform within the meter.

In transmit mode the processor 11 determines what data will be sent to a remote client. The data is formatted by the MAC hw/sw 14 and the PHY logic 13. The PHY logic 13 block includes a digital-to-analog converter (DAC) block that generates a modulated signal as an RF output. The RF output of the ASIC 10 is passed to the upconvert mixer 37 (FIG. 3) where it is mixed with a signal generated by the frequency synthesizer 38 in order to produce the appropriate RF for the communication channel. The output of the upconvert mixer 37 drives the input of the power amplifier 36 that generates the appropriate signal energy for the communication channel. The gain of the power amplifier 36 is adjusted by the processor 11 (FIG. 2) in accordance with the specifications for a given communication channel. The RF switch 33 (FIG. 3) is set to transmit mode such that the RF signal from the power amplifier 36 is passed through the antenna 31 for radiation.

DC Power

The power conditioning circuit 40 (FIG. 1) converts the AC voltage from the service side into the appropriate DC voltages for the display unit 20, the highly optimized ASIC 10, and the RF support circuitry 30. The DC voltages generated by the power conditioning circuit 40 are also applied to analog inputs 18 (FIG. 2) on the ASIC 10 in order to monitor the condition of each DC voltage. Anomalies in any or all of the DC voltages can be reported back to the remote client as part of the data messages sent through the communication channel.

SEM Implementation

The SEM is implemented using a single main PCB for the measurement and communications functions. The main PCB integrates the power conditioning 40 (FIG. 1) circuitry, the highly optimized ASIC 10, and the RF support circuitry 30. The display unit 20 may or may not be populated on the PCB depending upon the configuration of the SEM and the display unit 20 configuration.

All circuitry required by the power conditioning 40 circuit to convert the AC voltage from the service side into the appropriate DC voltages for the display unit 20, the highly optimized ASIC 10, and the RF support circuitry 30 is included on the main PCB. The ASIC 10 and all of its supporting components are populated on the SEM PCB. The RF path 30 is designed onto the main PCB and may or may not be populated during manufacturing depending upon the final configuration of a given SEM. The antenna 31 may or may not be populated on the main PCB depending upon the final configuration of the given SEM.

ASIC 10 Implementation (FIG. 2)

Key elements of the ASIC 10 implementation are the flexibility of the ADC 15, programmable performance of the processor 11, and the integration of PHY logic 13 and MAC hw/sw 14 functions. The ADC 15 is designed to operate at multiple sampling rates and resolutions. The highest sampling rate is determined by the highest frequency RF signal that is processed by the ADC 15. The active sampling rate and resolution depends upon the signal that is presently being sampled (i.e. AC voltage, RF input, DC voltage, etc.) The sample clocks for the ADC 15 are generated by the clock/timing 16 block under control of the processor 11.

The processor 11 can be run at different speeds depending upon the function that it is performing. For measurement only functions the speed of the processor 11 is reduced in order to conserve operating power. For communication only functions the processor 11 speed is increased to meet the demands of those functions. In cases where measurement and communications functions are running concurrently the processor 11 runs at its highest speed. The clock/timing 16 block manages the processor 111 clocks based on the current functions required. In all cases the processor 11 speed is optimized to provide sufficient bandwidth for the current task with minimum power consumption.

The PHY logic 13 is designed such that it may be conFIG.d to support multiple communications protocols including, but not limited to, such protocols that comply with IEEE 802.11x and 802.15x standards. The MAC hw/sw 14 block is also designed such that it may be conFIG.d to support multiple communications protocols including, but not limited to, such protocols that comply with IEEE 802.11x and 802.15x standards. This allows a single ASIC 10 implementation to support a variety of communication protocols through software control.

### CONCLUSION

The AMR-enabled solid-state electricity meter that utilizes a highly optimized ASIC is disclosed as both a method and apparatus that significantly reduces the cost of implementing an ASEM by directly integrating the AMR function onto the main PCB thereby eliminating the cost associated with producing and mounting a separate AMR module into a SEM. It achieves further cost reduction by implementing a highly optimized ASIC that integrates a complete metering measurement system with key elements of the AMR communication system. This eliminates redundant resources found in a separate metering ASIC and communications ASIC. Further efficiency is achieved by using a single programmable ADC to sample both the metering sensor inputs and the AMR communication receive path.

The foregoing description of the preferred embodiment of the invention is presented only for the purposes of explanation and illustration of said invention. It is not the intention of this description to provide a complete and exhaustive embodiment that in any way limits the invention to the exact form disclosed herein.

Thus, specific embodiments of an AMR-enabled solid-state electricity meter that utilizes a highly optimized ASIC have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. An apparatus for implementing an AMR-enabled solid-state utility meter comprising:
a solid-state utility meter having at least one integrated measurement channel for measuring utility consumption, and
at least one communication channel for communicating said consumption data to remote clients.

2. The apparatus for implementing an AMR-enabled solid-state utility meter according to claim 1 wherein the at least one integrated measurement channel and the at least one communication channel are integrated onto the same printed circuit board.

3. The apparatus for implementing an AMR-enabled solid-state utility meter according to claim 2 wherein a single application specific integrated circuit is used.

4. The apparatus for implementing an AMR-enabled solid-state utility meter according to claim 3 wherein the application specific integrated circuit integrates the said at least one integrated measurement channel and said at least one communication channel into a single device.

5. The apparatus for implementing an AMR-enabled solid-state utility meter according to claim 4, wherein the application specific integrated circuit integrates at least one analog-to-digital conversion circuit.

6. The apparatus for implementing an AMR-enabled solid-state utility meter according to claim 4, wherein a single analog-to-digital converter is time multiplexed such that it digitizes signals from said at least one integrated measurement channel and said at least one communication channel.

7. The apparatus for implementing an AMR-enabled solid-state utility meter according to claim 4 that further includes an analog-to-digital converter circuit that has a programmable sample rate and a programmable resolution.

8. The apparatus for implementing an AMR-enabled solid-state utility meter according to claim 4 wherein the signal from said at least one integrated measurement channel are mixable with the signal from the at least one communication channel to form a single input to an analog-to-digital converter.

9. The apparatus for implementing an AMR-enabled solid-state utility meter according to claim 5 wherein the t least one analog-to-digital conversion circuit has a programmable sample rate and a programmable resolution to sufficient to effectively digitize the at least one signal from the said at least one integrated measurement channel when they are mixable with the at least one signal from the at least one communication channel to form the at least one analog-to-digital converter.

10. The apparatus for implementing an AMR-enabled solid-state utility meter according to claim 5 wherein the application specific integrated circuit integrates a processor core with sufficient processing bandwidth to process both the at least one integrated measurement channel and the at least one communication channel.

11. The apparatus for implementing an AMR-enabled solid-state utility meter according to claim 5 wherein the application specific integrated circuit integrates a processor core with sufficient processing bandwidth to process both the at least one integrated measurement channel and the at least one communication channel concurrently and/or in time multiplexed.

12. The apparatus for implementing an AMR-enabled solid-state utility meter according to claim 5 wherein the processor core receives the digitized mixed signal of the at least one integrated measurement channel and at least one communication channel and separates the digitized signal back into at least one measurement channel and at least one communication channel.

13. The apparatus for implementing an AMR-enabled solid-state utility meter according to claim 5 wherein the application specific integrated circuit integrates dedicated signal processing logic including at least one of a multiply and a accumulate circuit for processing data from the at least one integrated measurement channel.

14. The apparatus for implementing an AMR-enabled solid-state utility meter according to claim 5 wherein the application specific integrated circuit integrates a dedicated signal processing logic to perform physical interface processing on the data from the at least one communication channel.

15. The apparatus for implementing an AMR-enabled solid-state utility meter according to claim 5 wherein the application specific integrated circuit integrates a dedicated signal processing logic to perform media access control processing on the data from the at least one communication channel.

16. The apparatus for implementing an AMR-enabled solid-state utility meter according to claim 5 wherein the application specific integrated circuit integrates internal memory for storing operating programs for use with a measurement function associated with the at least one integrated measurement channel and a communication function associated with the at least one communication channel.

17. The apparatus for implementing an AMR-enabled solid-state utility meter according to claim 5 that further includes using the at least one communication channel to new, updated, or replacement programs into memory.

18. The apparatus for implementing an AMR-enabled solid-state utility meter according to claim 1 that further includes a method of performing the functions.

19. The apparatus for implementing an AMR-enabled solid-state utility meter according to claim 5 that further includes a method of performing the functions.

20. The apparatus for implementing an AMR-enabled solid-state utility meter according to claim 17 that further includes a method of performing the functions.
